(19) United States
(12) Patent Application Publication
(10) Pub. No.: US 2025/0314805 A1
(43) Pub. Date: Oct. 9, 2025

(54) WEATHER FORECASTING DEVICE, WEATHER FORECASTING SYSTEM, AND WEATHER FORECASTING METHOD

(71) Applicant: Mitsubishi Electric Corporation, Tokyo (JP)

(72) Inventors: Naoya NOMURA, Tokyo (JP); Masato GOCHO, Tokyo (JP); Hiroai ASAMI, Tokyo (JP); Hiroshi OTSUKA, Tokyo (JP); Hiroshi SAKAMAKI, Tokyo (JP)

(73) Assignee: Mitsubishi Electric Corporation, Tokyo (JP)

(21) Appl. No.: 19/241,962

(22) Filed: Jun. 18, 2025

Related U.S. Application Data
(63) Continuation of application No. PCT/JP2023/005879, filed on Feb. 20, 2023.

(51) Int. Cl. G01W 1/10

(52) U.S. Cl. CPC G01W 1/10

(57) ABSTRACT

A weather forecasting device includes: an observation data acquiring unit that acquires grid data obtained by dividing a predetermined area including a forecasting target area into a plurality of grids and including weather data observed for each of the divided grids; a nonuniform grid constructing unit that subdivides a predetermined grid among the grids indicated by the grid data acquired by the observation data acquiring unit, combines a predetermined grid among the grids indicated by the grid data with a grid adjacent to the grid, and generates nonuniform grid data indicating a nonuniform grid in which the subdivided grid and the combined grid are mixed and including weather data for each of the grids; and a nonuniform grid forecast processing unit that forecasts weather data of the forecasting target area included in the predetermined area using the nonuniform grid data generated by the nonuniform grid constructing unit.

### CROSS REFERENCE TO RELATED APPLICATION

This application is a Continuation of PCT International Application No. PCT/JP2023/005879, filed on Feb. 20, 2023, which is hereby expressly incorporated by reference into the present application.

### TECHNICAL FIELD

The present disclosure relates to a weather forecasting device, a weather forecasting system, and a weather forecasting method.

### BACKGROUND ART

Conventionally, a weather forecasting device that forecasts weather in a forecasting target area is known. In a weather forecasting system using this weather forecasting device, a future weather condition such as rain or wind in a forecasting target area is forecasted from weather data such as temperature, humidity, and atmospheric pressure observed in the forecasting target area.

In order to capture local concentrated heavy rain, tornado, and the like, information of a grid (mesh) obtained by finely dividing a forecasting target area is required, but in order to perform long-time forecast, it is necessary to consider information of a relatively wide range therearound. However, in general, in a case where forecast is performed for a wide range using a fine grid, a computer handles an enormous amount of data, and thus not only a scale of the computer increases, but also a calculation time increases.

Therefore, in a conventional weather forecasting system, there has been proposed a technique for shortening a calculation time required for forecast by a method for first forecasting a global weather condition and then forecasting a weather condition at a specific local spot, called a nesting method.

For example, Patent Literature 1 discloses a system that forecasts how a diffusion substance emitted from a spot of interest is diffused by a local air flow element. In this system, in order to forecast a diffusion state of the diffusion substance emitted from the spot of interest, a local area A1 including the spot of interest, a middle area A2 including the local area A1, and a large area A3 (A1<A2<A3) including the middle area A2 are set. Then, by calculating an air flow in the middle area A2 and the large area A3 wider than the local area A1 and forecasting the air flow in the local area A1 using a result of the calculation, a processing load is reduced and a processing time is shortened.

### CITATION LIST

### Patent Literature

Patent Literature 1: JP 2008-89418 A

### SUMMARY OF INVENTION

### Technical Problem

In the system described in Patent Literature 1 (hereinafter, also referred to as a “conventional system”), evaluation spots arranged at predetermined intervals in a grid shape are set in advance for each of the local area A1, the middle area A2, and the large area A3. In the conventional system, by obtaining air flow data for each evaluation spot set for each of the above areas, and performing diffusion calculation using the air flow data, a diffusion state of the diffusion substance emitted from the spot of interest is forecasted.

However, in the conventional system, since the evaluation spots used for forecasting the diffusion state are fixedly arranged at predetermined intervals for each of the above areas, there is a problem that it cannot be said that the system has a sufficient configuration in a case where it is desired to further improve forecasting accuracy of the diffusion state.

The present disclosure has been made in order to solve the above problem, and an object of the present disclosure is to obtain a weather forecasting device capable of improving forecasting accuracy of a weather condition while suppressing an increase in processing load as compared with related art.

### Solution to Problem

A weather forecasting device according to the present disclosure includes processing circuitry to acquire grid data obtained by dividing a predetermined area including a forecasting target area into a plurality of grids and including weather data observed for each of the plurality of grids, to perform subdivision of a predetermined grid among the plurality of grids indicated by the grid data to be subdivided grids, to perform combination of another predetermined grid among the plurality of grids indicated by the grid data with a grid adjacent to said another predetermined grid to be a combined gird, and to generate nonuniform grid data indicating nonuniform grids in which the subdivided grids and the combined grid are included and including weather data for each of the nonuniform grids, and to perform forecast of weather data of the forecasting target area included in the predetermined area using the nonuniform grid data.

### Advantageous Effects of Invention

According to the present disclosure, it is possible to improve forecasting accuracy of a weather condition while suppressing an increase in processing load as compared with related art.

### BRIEF DESCRIPTION OF DRAWINGS

FIG. 1 is a diagram illustrating a configuration example of a weather forecasting system including a weather forecasting device according to a first embodiment.

FIG. 2 is a flowchart for explaining an operation example of the weather forecasting device according to the first embodiment.

FIG. 3A is a diagram illustrating an example of observation data in the first embodiment, FIG. 3B is a diagram illustrating an example of selection by an area selecting unit in the first embodiment, and FIG. 3C is a diagram illustrating an example of a nonuniform grid in the first embodiment.

FIG. 4 is a diagram illustrating an example of adjacent grid determining data in the first embodiment.

FIG. 5 is a diagram illustrating an example of interpolation processing by a nonuniform grid forecast processing unit in the first embodiment.

FIGS. 6A and 6B are each a diagram illustrating an example of a hardware configuration of the weather forecasting device according to the first embodiment.

FIG. 7 is a diagram illustrating a configuration example of a weather forecasting system including a weather forecasting device according to a second embodiment.

FIG. 8 is a flowchart for explaining an operation example of the weather forecasting device according to the second embodiment.

FIG. 9 is a diagram illustrating a configuration example of a weather forecasting system including a weather forecasting device according to a third embodiment.

FIG. 10 is a flowchart for explaining an operation example of the weather forecasting device according to the third embodiment.

FIG. 11 is a diagram illustrating a configuration example of a weather forecasting system including a weather forecasting device according to a fourth embodiment.

FIG. 12 is a flowchart for explaining an operation example of the weather forecasting device according to the fourth embodiment.

FIG. 13 is a diagram illustrating an example of selection by an area selecting unit in the fourth embodiment.

FIG. 14 is a diagram illustrating a configuration example of a weather forecasting system including a weather forecasting device according to a fifth embodiment.

### DESCRIPTION OF EMBODIMENTS

Hereinafter, embodiments of the present disclosure will be described in detail with reference to the drawings.

### First Embodiment

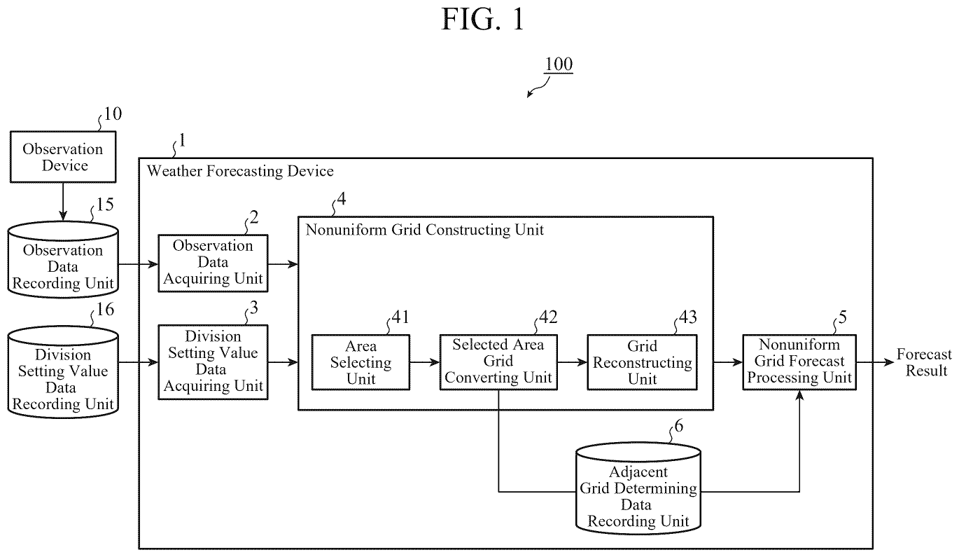

FIG. 1 is a diagram illustrating a configuration example of a weather forecasting system 100 including a weather forecasting device 1 according to a first embodiment. For example, as illustrated in FIG. 1, the weather forecasting system 100 includes an observation device 10, an observation data recording unit 15, a divided setting value data recording unit 16, and the weather forecasting device 1.

### <Observation Device 10>

The observation device 10 observes a weather condition (weather data) in a predetermined area including an area to be subjected to weather forecast (hereinafter, also referred to as a “forecasting target area”). The observation device 10 is disposed, for example, at any position in a predetermined area including a forecasting target area or at any position in the vicinity of the predetermined area.

The observation device 10 observes a weather condition in the predetermined area, for example, at a predetermined time set in advance, and generates observation data D1. The observation data D1 is, for example, grid data obtained by dividing the predetermined area into a plurality of grids. In addition, this grid data includes weather data observed for each of the grids.

For example, in a case where the predetermined area is divided into a total of nine grids (grid cells) of three rows and three columns, and each of the grids is expressed by a grid (i, j), the observation data D1 includes, as weather data for each grid, data such as
a grid (1,1)=(sunny, north wind, temperature 15° C., humidity 26%, . . . ),
a grid (1,2)=(sunny, east wind, temperature 17° C., humidity 30%, . . . ),
a grid (1,3)=(cloudy, west wind, temperature 12° C., humidity 45%, . . . ),
a grid (2,1)=(sunny, north wind, temperature 16° C., humidity 28%, . . . ),
a grid (2,2)=(sunny, east wind, temperature 14° C., humidity 32%, . . . ),
a grid (2,3)=(cloudy, west wind, temperature 13° C., humidity 48%, . . . ),
a grid (3,1)=(sunny, north wind, temperature 11° C., humidity 25%, . . . ),
a grid (3,2)=(sunny, east wind, temperature 13° C., humidity 33%, . . . ), or
a grid (3,3)=(cloudy, west wind, temperature 10° C., humidity 50%, . . . ). The observation device 10 generates the observation data D1, for example, including weather data for each grid as described above and causes the observation data recording unit 15 to record the generated observation data D1.

The observation data recording unit 15 is constituted by a recording medium such as a hard disk drive (HDD) or a solid state drive (SSD). The observation data recording unit 15 records the observation data D1 generated by the observation device 10.

The divided setting value data recording unit 16 is constituted by a recording medium such as a hard disk drive (HDD) or a solid state drive (SSD). The divided setting value data recording unit 16 records divided setting value data D2.

The divided setting value data D2 is a parameter used when a nonuniform grid constructing unit 4 described later performs grid conversion. Specifically, the divided setting value data D2 is data (hereinafter, also referred to as “conversion target data”) designating a grid to be subjected to grid conversion among a plurality of grids included in the predetermined area. Note that, as will be described in detail later, the grid conversion means making a grid finer (subdividing a grid) or making a grid coarser (combining grids).

For example, the divided setting value data D2 is data designating a grid that is to be made finer (subdivided) and a grid that is to be made coarser (combined). Note that, here, “making a grid finer” means subdividing an area inside a grid, and “making a grid coarser” means combining a certain grid with a grid adjacent to the grid into one grid. In addition, in the following description, a grid to be made finer is also referred to as a “subdividing target grid”, and a grid to be made coarser is also referred to as a “combining target grid”.

For example, in the case of a total of nine grids of three rows and three columns described above, in the divided setting value data D2, the grid (1,1), the grid (1,3), and the grid (2,1) are designated as subdividing target grids, and the grid (3,3) is designated as a combining target grid. Note that the divided setting value data D2 is generated in advance, for example, by a user of the weather forecasting system 100 (hereinafter, also simply referred to as a “user”), and is recorded in the divided setting value data recording unit 16.

Here, “making an area inside a grid finer (subdividing an area inside a grid)” intends to forecast weather data in a forecasting target area with higher accuracy by making a certain grid finer and performing subsequent processing.

For example, the user designates a grid including the forecasting target area as a subdividing target grid in the divided setting value data D2. In addition, in a case where there is an area in which a weather element (for example, typhoon or yellow sand) that largely affects weather forecast in the forecasting target area can occur, the user designates a grid including such an area (for example, a typhoon-prone area or a desert area in consideration of yellow sand) as the subdividing target grid in the divided setting value data D2. Note that, in the following description, the area in which a weather element that largely affects weather forecast in the forecasting target area can occur is also referred to as an “influence area”.

Meanwhile, “making an area inside a grid coarser (combining an area inside a grid)” intends to perform forecast processing while suppressing an increase in processing load and calculation cost by combining a certain grid and a grid adjacent to the grid and perform subsequent processing.

For example, in a case where an area in which weather data does not change so much and which includes a land with little undulation is included in a predetermined area, highly accurate forecast with a fine grid is not necessary for such an area, and it may be sufficient to perform forecast on the basis of a grid having a certain size. Therefore, the user designates a grid including an area in which weather data does not change so much or an area in which temporal change of weather data is poor as a combining target grid in the divided setting value data D2. Note that the “area in which weather data does not change so much” or the “area in which temporal change of weather data is poor” means, for example, an area in which the amount of change in weather data at a predetermined time interval (for example, five minutes) is equal to or less than a predetermined value. In addition, in the following description, such an area is also referred to as a “monotonous area”.

### <Weather Forecasting Device 1>

For example, as illustrated in FIG. 1, the weather forecasting device 1 includes an observation data acquiring unit 2 (first acquisition unit), a divided setting value data acquiring unit 3 (second acquisition unit), a nonuniform grid constructing unit 4 (generation unit), a nonuniform grid forecast processing unit 5 (forecast processing unit), and an adjacent grid determining data recording unit 6.

The observation data acquiring unit 2 acquires the observation data D1 (grid data) from the observation data recording unit 15. The observation data acquiring unit 2 outputs the acquired observation data D1 to the nonuniform grid constructing unit 4.

The divided setting value data acquiring unit 3 acquires the divided setting value data D2 from the divided setting value data recording unit 16. The divided setting value data acquiring unit 3 outputs the acquired divided setting value data D2 to the nonuniform grid constructing unit 4. Note that, here, in the divided setting value data D2, for example, a grid including a forecasting target area and a grid including an influence area are designated as subdividing target grids, and a grid including a monotonous area is designated as a combining target grid.

The nonuniform grid constructing unit 4 acquires the observation data D1 from the observation data acquiring unit 2. In addition, the nonuniform grid constructing unit 4 acquires the divided setting value data D2 from the divided setting value data acquiring unit 3. Then, by subdividing a predetermined grid among grids indicated by the observation data D1 and combining a predetermined grid among the grids indicated by the observation data D1 with a grid adjacent to the grid, the nonuniform grid constructing unit 4 constructs a grid in which the subdivided grid and the combined grid are mixed (hereinafter, also referred to as a “nonuniform grid”), and generates data indicating the nonuniform grid (hereinafter, also referred to as “nonuniform grid data”). At this time, the nonuniform grid constructing unit 4 selects a grid to be subdivided (subdividing target grid) and a grid to be combined (combining target grid) on the basis of, for example, the divided setting value data D2 acquired from the divided setting value data acquiring unit 3.

### <Nonuniform Grid Constructing Unit 4>

For example, as illustrated in FIG. 1, the nonuniform grid constructing unit 4 includes an area selecting unit 41, a selected area grid converting unit 42, and a grid reconstructing unit 43.

The area selecting unit 41 selects a subdividing target grid and a combining target grid from grids indicated by the observation data D1 on the basis of the divided setting value data D2. The area selecting unit 41 outputs data indicating the selected result to the selected area grid converting unit 42.

The selected area grid converting unit 42 acquires the data indicating the selection result from the area selecting unit 41, and performs grid conversion on the basis of the acquired data. Specifically, for example, the selected area grid converting unit 42 temporarily extracts the subdividing target grid selected by the area selecting unit 41 from the observation data D1, and subdivides the extracted subdividing target grid into a predetermined number of grids. In addition, for example, the selected area grid converting unit 42 temporarily extracts the combining target grid selected by the area selecting unit 41 from the observation data D1, and combines the extracted combining target grid with an adjacent grid. The selected area grid converting unit 42 outputs data indicating a result of the grid conversion (subdivision and combination) to the grid reconstructing unit 43.

In addition, the selected area grid converting unit 42 generates adjacent grid determining data D3 indicating an adjacency relationship between grids in the observation data D1 (grid data) after the grid conversion. Then, the selected area grid converting unit 42 causes the adjacent grid determining data recording unit 6 to record the generated adjacent grid determining data D3.

The adjacent grid determining data recording unit 6 is constituted by a recording medium such as a hard disk drive (HDD) or a solid state drive (SSD). The adjacent grid determining data recording unit 6 records the adjacent grid determining data D3.

The grid reconstructing unit 43 acquires data indicating a result of the grid conversion from the selected area grid converting unit 42. The grid reconstructing unit 43 constructs a grid (nonuniform grid) in which the subdivided grid and the combined grid are mixed on the basis of the acquired data, and generates data (nonuniform grid data) indicating the nonuniform grid. The grid reconstructing unit 43 outputs the generated nonuniform grid data to the nonuniform grid forecast processing unit 5.

The nonuniform grid forecast processing unit 5 acquires the nonuniform grid data from the grid reconstructing unit 43. The nonuniform grid forecast processing unit 5 forecasts weather data of a forecasting target area included in a predetermined area using the acquired nonuniform grid data and the adjacent grid determining data D3 recorded in the adjacent grid determining data recording unit 6. Then, the nonuniform grid forecast processing unit 5 outputs the forecasted weather data of the forecasting target area as a forecast result.

At this time, in the nonuniform grid indicated by the nonuniform grid data, a grid including the forecasting target area is subdivided, and a grid including a monotonous area is combined with an adjacent grid. Therefore, the nonuniform grid forecast processing unit 5 can compensate for an increase in processing load in the subdivided grid by a decrease in processing load in the combined grid. As a result, the nonuniform grid forecast processing unit 5 can perform weather forecast in the forecasting target area with high accuracy while suppressing an increase in processing load as the entire forecast processing.

In the nonuniform grid, a grid including an influence area is also subdivided. As a result, the nonuniform grid forecast processing unit 5 can accurately reflect an influence of a weather element occurring in the influence area in the forecasting target area, and can further improve the accuracy of the weather forecast in the forecasting target area.

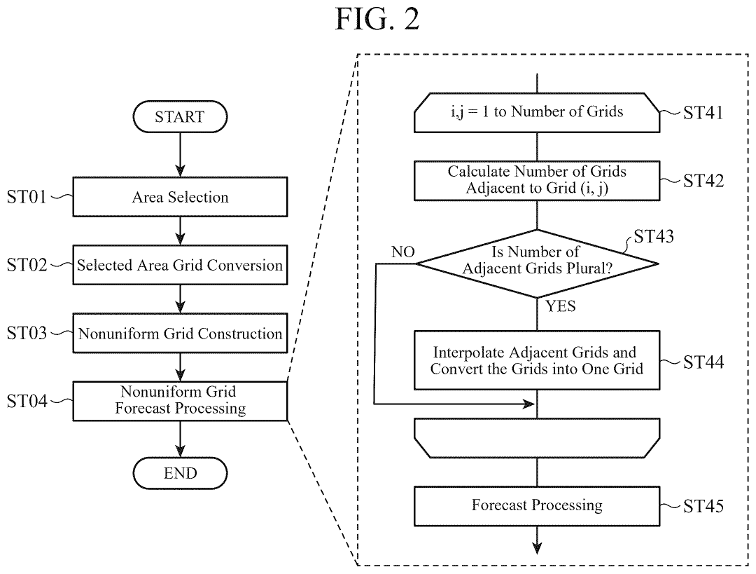

Next, an operation example of the weather forecasting device 1 according to the first embodiment will be described with reference to the flowchart illustrated in FIG. 2.

Note that, in the following description, in order to simplify the description, it is assumed that the observation data acquiring unit 2 of the weather forecasting device 1 has acquired the observation data D1 from the observation data recording unit 15 in advance, and has output the acquired observation data D1 to the nonuniform grid constructing unit 4. Similarly, it is assumed that the divided setting value data acquiring unit 3 of the weather forecasting device 1 has acquired the divided setting value data D2 from the divided setting value data recording unit 16 in advance, and has output the acquired divided setting value data D2 to the nonuniform grid constructing unit 4.

In addition, in the following description, in the divided setting value data D2, it is assumed that a grid including a forecasting target area and a grid including an influence area are designated as subdividing target grids, and a grid including a monotonous area is designated as a combining target grid.

First, the area selecting unit 41 of the nonuniform grid constructing unit 4 selects a subdividing target grid and a combining target grid from grids indicated by the observation data D1 on the basis of the divided setting value data D2 (step ST01).

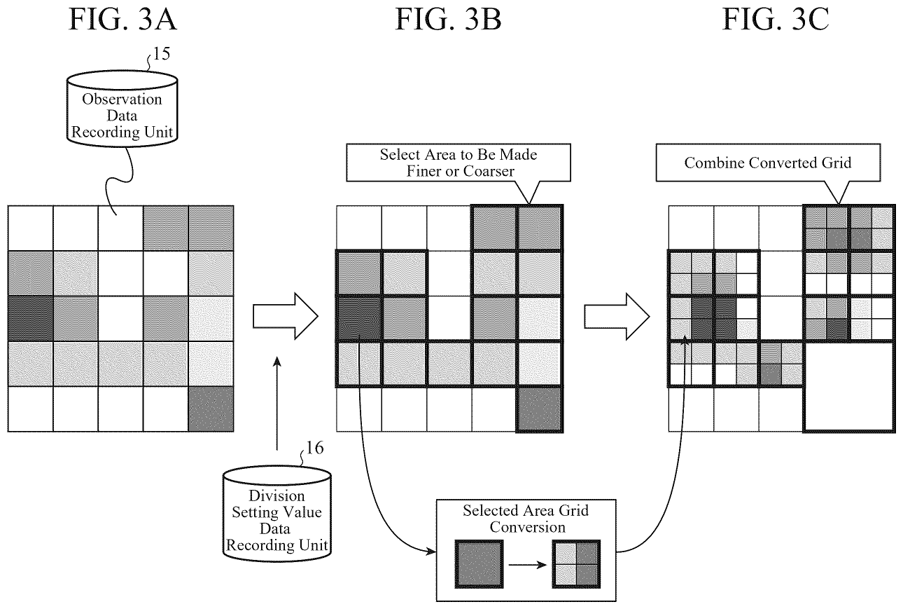

Here, an example of processing performed by the nonuniform grid constructing unit 4 including the area selecting unit 41 is illustrated in FIG. 3. FIG. 3A illustrates an example of the observation data D1 (grid data) acquired from the observation data recording unit 15. Note that each grid indicated by the observation data D1 illustrated in FIG. 3A includes weather data for each grid as described above. In FIG. 3A, a difference in this weather data is represented by shading of a grid.

For example, as illustrated in FIG. 3B, the area selecting unit 41 selects a subdividing target grid and a combining target grid from grids indicated by the observation data D1 on the basis of the divided setting value data D2 acquired from the divided setting value data recording unit 16. For example, in FIG. 3B, a grid surrounded by a thick line indicates a grid selected as a subdividing target grid or a combining target grid.

Next, the selected area grid converting unit 42 performs grid conversion on the grid selected by the area selecting unit 41 (step ST02). Specifically, the selected area grid converting unit 42 subdivides the subdividing target grid selected by the area selecting unit 41 and combines the combining target grids selected by the area selecting unit 41.

For example, as illustrated in FIG. 3B, the selected area grid converting unit 42 temporarily extracts the subdividing target grid from the observation data D1, and subdivides the extracted subdividing target grid into, for example, four grids. Note that, for example, the user can set, in any manner, how many grids the subdividing target grid is subdivided into by the selected area grid converting unit 42 in the divided setting value data D2.

Although not illustrated in FIG. 3B, the selected area grid converting unit 42 only needs to combine the combining target grid similarly to the case of subdividing the subdividing target grid. For example, the selected area grid converting unit 42 only needs to temporarily extract the combining target grid and grids (adjacent grids) adjacent to the combining target grid in the east, west, north, and south (up, down, left, and right) from the observation data D1, collect the extracted grids together, and form one grid. In addition to the above, the selected area grid converting unit 42 may temporarily extract grids adjacent to the combining target grid in oblique directions from the observation data D1, collect the extracted grids together, and form one grid. Note that, including the above example, the user can set, in any manner, up to what range of adjacent grids are collected together with the combining target grid by the selected area grid converting unit 42 in the divided setting value data D2.

Note that, after performing the grid conversion as described above, the selected area grid converting unit 42 needs to supplement weather data in the converted grid. In this case, for example, the selected area grid converting unit 42 may instruct the observation data acquiring unit 2 to reacquire the weather data in the converted grid from the observation device 10. When receiving this instruction, the observation data acquiring unit 2 reacquires the weather data in the converted grid from the observation device 10, and outputs the reacquired weather data to the selected area grid converting unit 42. Then, the selected area grid converting unit 42 only needs to supplement the reacquired weather data as the weather data in the converted grid.

Alternatively, the selected area grid converting unit 42 may supplement the weather data in the converted grid by interpolating the weather data on the basis of weather data in a grid adjacent to the converted grid. When supplementing weather data as described above, the selected area grid converting unit 42 outputs data indicating a result of the grid conversion including the supplemented weather data to the grid reconstructing unit 43.

In addition, at this time, the selected area grid converting unit 42 generates the adjacent grid determining data D3 and causes the adjacent grid determining data recording unit 6 to record the generated adjacent grid determining data D3. As described above, the adjacent grid determining data D3 indicates an adjacency relationship between grids in the grids indicated by the observation data D1 (that is, nonuniform grid data) after the selected area grid converting unit 42 performs the grid conversion.

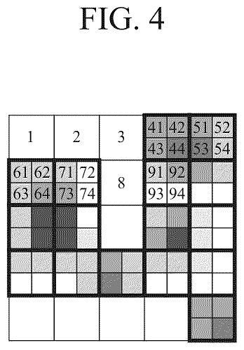

An example of the adjacent grid determining data D3 will be described with reference to FIG. 4. FIG. 4 is an example of a nonuniform grid. Note that, in FIG. 4, display of a combining target grid is omitted for convenience of description. In addition, in FIG. 4, a number for identifying each grid is attached to each grid for convenience of description.

In a case where the nonuniform grid is the example illustrated in FIG. 4, the adjacent grid determining data D3 is generated, for example, as follows:
a grid adjacent to grid 1=(grid 61, grid 62, and grid 2),
a grid adjacent to grid 2=(grid 1, grid 71, grid 72, and grid 3),
a grid adjacent to grid 3=(grid 2, grid 8, grid 41, and grid 43),
a grid adjacent to grid 41=(grid 3, grid 42, and grid 43),
a grid adjacent to grid 42=(grid 41, grid 44, and grid 51),
a grid adjacent to grid 43=(grid 3, grid 41, grid 44, and grid 91),
a grid adjacent to grid 44=(grid 42, grid 43, grid 53, and grid 92),
a grid adjacent to grid 51=(grid 42, grid 52, and grid 53), and
a grid adjacent to grid 52=(grid 51 and grid 54).

Next, the grid reconstructing unit 43 constructs a nonuniform grid in which a subdivided grid and a combined grid are mixed, for example, as illustrated in FIG. 3C on the basis of the data indicating the result of the grid conversion, acquired from the selected area grid converting unit 42, and generates nonuniform grid data indicating the nonuniform grid (step ST03). Note that, in the example of FIG. 3C, the subdivided grid is subdivided into four grids. In addition, in the example of FIG. 3C, the grid indicated by a lower right blank is a combined grid.

For example, as illustrated in FIG. 3C, the grid reconstructing unit 43 returns a grid subdivided by the selected area grid converting unit 42 to an original position thereof in the observation data D1 and combines the grid with another grid. In this case, the grid reconstructing unit 43 preferably stores the original position of the subdivided grid in the observation data D1 in advance.

Note that FIG. 3C illustrates a case where the grid reconstructing unit 43 returns the subdivided grid to an original position thereof in the observation data D1, but the same applies to a case where the grid reconstructing unit 43 returns a combined grid to an original position thereof in the observation data D1. The grid reconstructing unit 43 outputs the nonuniform grid data generated as described above to the nonuniform grid forecast processing unit 5.

Note that, in the above example, an example has been described in which the selected area grid converting unit 42 temporarily extracts the subdividing target grid and the combining target grid selected by the area selecting unit 41 from the observation data D1, and subdivides and combines the extracted grids, respectively, and the grid reconstructing unit 43 returns the subdivided or combined grid to an original position thereof in the observation data D1. However, the selected area grid converting unit 42 is not limited thereto, and may generate the nonuniform grid data by constructing the nonuniform grid by subdividing the subdividing target grid or the like selected by the area selecting unit 41 at the same position without extracting the subdividing target grid or the like from the observation data D1. In this case, the grid reconstructing unit 43 may be omitted.

In addition, in the above example, an example has been described in which the selected area grid converting unit 42 generates the adjacent grid determining data D3 and causes the adjacent grid determining data recording unit 6 to record the adjacent grid determining data D3, but it is not limited thereto, and for example, the grid reconstructing unit 43 may generate the adjacent grid determining data D3 and cause the adjacent grid determining data recording unit 6 to record the adjacent grid determining data D3.

Next, the nonuniform grid forecast processing unit 5 forecasts weather data of a forecasting target area included in a predetermined area using the nonuniform grid data acquired from the grid reconstructing unit 43 and the adjacent grid determining data D3 recorded in the adjacent grid determining data recording unit 6 (step ST04).

Here, a weather forecasting method by the nonuniform grid forecast processing unit 5 will be described in comparison with a conventional weather forecasting method using grid data.

For example, in conventional weather forecast, basically, on a premise that data (hereinafter, also referred to as “uniform grid data”) indicating a grid (hereinafter, also referred to as a “uniform grid”) configured in such a manner that grids are adjacent to each other on a one-to-one basis is used, weather forecast of a forecasting target area is performed by referring to weather data of each grid in the uniform grid.

For example, in the conventional weather forecast, weather forecast is performed by repeating calculation using a total of seven grids including a certain grid in a uniform grid, four grids adjacent to the grid in the east, west, north, and south (up, down, left, and right), and two grids adjacent to the grid in a height direction, called seven-point stencil calculation. Specifically, for example, in the conventional weather forecast, weather data (temperature, humidity, and the like) in each of the seven grids is multiplied by a predetermined weighting factor or the like, and then predetermined calculation such as addition or multiplication is performed on each piece of the weather data. In the conventional weather forecast, weather data of a forecasting target area is forecasted by sequentially repeating this calculation in such a manner that all the grids included in the grid data are calculation targets.

Meanwhile, in a nonuniform grid in which a subdivided grid and a combined grid are mixed, an adjacency relationship between the grids is not necessarily one-to-one. For example, as illustrated in FIG. 4, as a result of the grid conversion by the selected area grid converting unit 42, a state in which a plurality of grids is adjacent to a combined grid on any one side (for example, on the east side) of the combined grid may occur. Note that, in the following description, a relationship in which a plurality of grids is adjacent to one grid on any one side of the grid as described above is also referred to as a “nonuniform adjacency relationship”. In this case, the nonuniform grid forecast processing unit 5 cannot perform processing using the conventional method as described above.

Therefore, the nonuniform grid forecast processing unit 5 specifies a set of grids having a nonuniform adjacency relationship by referring to the adjacent grid determining data D3 recorded in the adjacent grid determining data recording unit 6. Then, the nonuniform grid forecast processing unit 5 substantially cancels the nonuniform adjacency relationship by performing interpolation processing on the specified set of grids.

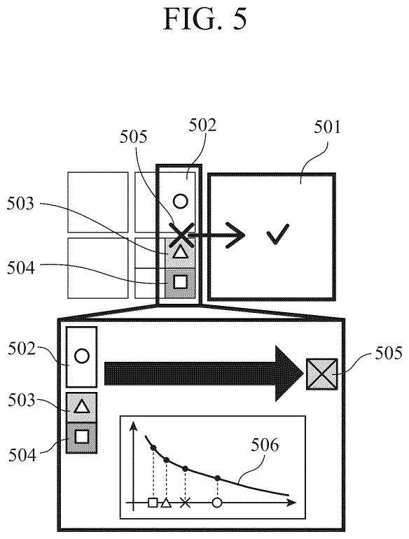

FIG. 5 illustrates an example of interpolation processing by the nonuniform grid forecast processing unit 5. For example, in FIG. 5, reference numeral 501 denotes a combined grid (check mark), and reference numerals 502 to 504 denotes grids (o, Δ4, ando□respectively) adjacent to the grid 501 on the left of the grid 501. At this time, the size of the grid is as follows: grid 501>grid 502>grid 503=grid 504.

In this case, for example, the nonuniform grid forecast processing unit 5 determines whether or not a plurality of grids is adjacent to the grid 501 in the east, west, north, and south (up, down, left, and right) directions on the basis of the adjacent grid determining data D3. For example, in the example of FIG. 5, three grids (grids 502 to 504) are adjacent to the grid 501 on the west side (left side) of the grid 501. In this case, the nonuniform grid forecast processing unit 5 determines that these grids 501 to 504 have a nonuniform adjacency relationship.

Then, for example, as illustrated in FIG. 5, the nonuniform grid forecast processing unit 5 first interpolates the grids 502 to 504 at a midpoint position, and as a result, obtains a new grid 505 (x).

For example, a graph 506 illustrated in FIG. 5 schematically illustrates weather data (for example, temperature, humidity, or atmospheric pressure) in the grids 502 to 504. “o”, “Δ”, and “□” on the horizontal axis of the graph 506 correspond to symbols “o”, “Δ”, and “□” attached to the grids, respectively, and “x” on the horizontal axis of the graph 506 corresponds to the new grid “x” obtained as a result of the interpolation.

For example, when the weather data is temperature, temperature in the grid 504 denoted by the symbol “□” is 20° C., temperature in the grid 503 denoted by the symbol “Δ” is 19° C., and temperature in the grid 502 denoted by the symbol “o” is 16° C., the nonuniform grid forecast processing unit 5 sets temperature in the grid 505 denoted by the symbol “x” to 18° C. as a result of interpolating these temperatures.

As a result, only one grid 505 denoted by the symbol “x” is adjacent to the grid 501 denoted by a check mark on the left of the grid 501. Then, the nonuniform grid forecast processing unit 5 sequentially performs such processing on a set of grids having a nonuniform adjacency relationship. As a result, the nonuniform grid forecast processing unit 5 can perform calculation by a conventional method using the nonuniform grid data acquired from the grid reconstructing unit 43.

The above processing will be described on the basis of the flowchart of FIG. 2. In a case where each of grids in the nonuniform grid is expressed by (i, j), the nonuniform grid forecast processing unit 5 refers to the grids one by one while counting up i and j from 1 (step ST41). Note that i is a variable indicating the position of each grid in the east-west direction (left-right direction), and j is a variable indicating the position of each grid in the north-south direction (up-down direction).

Next, the nonuniform grid forecast processing unit 5 calculates the number of grids adjacent to the grid (i, j) in each direction of the east, west, north, and south on the basis of the adjacent grid determining data D3 (step ST42).

Then, the nonuniform grid forecast processing unit 5 determines whether or not the number of grids adjacent to the grid (i, j) in each direction of the east, west, north, and south is plural (step ST43). As a result, if it is determined that the number of grids adjacent to the grid (i, j) in each direction of the east, west, north, and south is plural (step ST43; YES), the nonuniform grid forecast processing unit 5 interpolates the grids by interpolation processing as described above, and converts the grids into one grid (step ST44). Thereafter, the process returns to step ST41.

Meanwhile, if it is determined that the number of grids adjacent to the grid (i, j) in each direction of the east, west, north, and south is not plural (step ST43; NO), the process returns to step ST41.

Thereafter, the nonuniform grid forecast processing unit 5 repeats the processing of steps ST41 to ST44 for each of the grids. Thereafter, the process proceeds to step ST45, and the nonuniform grid forecast processing unit 5 forecasts weather data in the forecasting target area using the nonuniform grid data for which the processing of steps ST41 to ST44 has been completed (step ST45).

Note that, in the weather forecasting device 1, even when the nonuniform grid forecast processing unit 5 performs the interpolation processing as described above, grid conversion may be performed again on grids (for example, the grids 502 to 504 illustrated in FIG. 5) before the interpolation. Therefore, even when the interpolation processing as described above is performed, the nonuniform grid forecast processing unit 5 preferably leaves data related to the grids before the interpolation as it is without deleting the data from the observation data D1. In addition, for a similar reason to that described above, the nonuniform grid forecast processing unit 5 preferably does not update the adjacent grid determining data D3 generated at a time point before the interpolation.

In addition, in a case where the interpolation processing as described above is performed, the nonuniform grid forecast processing unit 5 may add data (weather data or the like) related to the newly obtained grid 505 to the observation data D1 from a viewpoint of improving efficiency. In addition, in the above case, the nonuniform grid forecast processing unit 5 may add adjacent information between grids after the interpolation (for example, information indicating that the grid 505 and the grid 501 illustrated in FIG. 5 are adjacent to each other) to the adjacent grid determining data D3 from a viewpoint of improving efficiency.

By performing the processing as described above, the nonuniform grid forecast processing unit 5 can forecast weather data of the forecasting target area using the nonuniform grid data. In particular, in the above example, in the nonuniform grid indicated by the nonuniform grid data, a grid including the forecasting target area is subdivided, while a grid including the monotonous area is combined with an adjacent grid. Therefore, the nonuniform grid forecast processing unit 5 can compensate for an increase in processing load in the subdivided grid by a decrease in processing load in the combined grid. As a result, the nonuniform grid forecast processing unit 5 can perform weather forecast in the forecasting target area with high accuracy while suppressing an increase in processing load as the entire forecast processing.

In addition, in the above example, in the nonuniform grid indicated by the nonuniform grid data, a grid including the influence area is also subdivided. As a result, the nonuniform grid forecast processing unit 5 can accurately reflect an influence of a weather element occurring in the influence area in the forecasting target area, and can further improve the accuracy of the weather forecast in the forecasting target area.

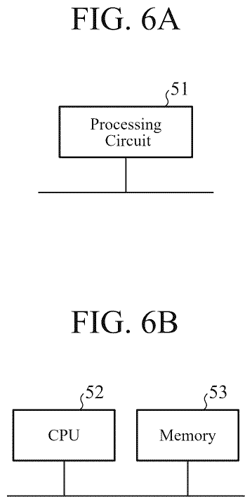

Next, a hardware configuration example of the weather forecasting device 1 according to the first embodiment will be described with reference to FIG. 6. Functions of the observation data acquiring unit 2, the divided setting value data acquiring unit 3, the nonuniform grid constructing unit 4 (the area selecting unit 41, the selected area grid converting unit 42, and the grid reconstructing unit 43), and the nonuniform grid forecast processing unit 5 in the weather forecasting device 1 are implemented by a processing circuit. The processing circuit may be dedicated hardware as illustrated in FIG. 6A, or a central processing unit (CPU, also referred to as a central processing device, a processing device, a calculation device, a microprocessor, a microcomputer, a processor, or a digital signal processor (DSP)) 52 that executes a program stored in a memory 53 as illustrated in FIG. 6B.

In a case where the processing circuit is dedicated hardware, for example, a single circuit, a composite circuit, a programmed processor, a parallel programmed processor, an application specific integrated circuit (ASIC), a field programmable gate array (FPGA), or a combination thereof corresponds to the processing circuit 51. Each of the functions of the observation data acquiring unit 2, the divided setting value data acquiring unit 3, the nonuniform grid constructing unit 4, and the nonuniform grid forecast processing unit 5 may be implemented by the processing circuit 51, or the functions of the units may be collectively implemented by the processing circuit 51.

When the processing circuit is the CPU 52, the functions of the observation data acquiring unit 2, the divided setting value data acquiring unit 3, the nonuniform grid constructing unit 4, and the nonuniform grid forecast processing unit 5 are implemented by software, firmware, or a combination of the software and the firmware. The software and the firmware are each described as a program and stored in the memory 53. By reading and executing the program recorded in the memory 53, the processing circuit implements the functions of the units. That is, the weather forecasting device 1 includes the memory for storing a program that causes the steps, for example, illustrated in FIG. 2 to be executed as a result when the program is executed by the processing circuit. It can also be said that these programs cause a computer to execute procedures and methods performed by the observation data acquiring unit 2, the divided setting value data acquiring unit 3, the nonuniform grid constructing unit 4, and the nonuniform grid forecast processing unit 5. To the memory 53, for example, a nonvolatile or volatile semiconductor memory such as a random access memory (RAM), a read only memory (ROM), a flash memory, an erasable programmable ROM (EPROM), or an electrically-EPROM (EEPROM), a magnetic disk, a flexible disk, an optical disc, a compact disc, a mini disc, a digital versatile disc (DVD), or the like corresponds.

Note that some of the functions of the observation data acquiring unit 2, the divided setting value data acquiring unit 3, the nonuniform grid constructing unit 4, and the nonuniform grid forecast processing unit 5 may be implemented by dedicated hardware, and some of the functions may be implemented by software or firmware. For example, the function of the observation data acquiring unit 2 can be implemented by the processing circuit as dedicated hardware, and the functions of the divided setting value data acquiring unit 3, the nonuniform grid constructing unit 4, and the nonuniform grid forecast processing unit 5 can be implemented by the processing circuit reading and executing a program stored in the memory 53.

In this way, the processing circuitry can implement the above-described functions by hardware, software, firmware, or a combination thereof.

As described above, according to the first embodiment, the weather forecasting device 1 includes: the observation data acquiring unit 2 that acquires grid data (observation data D1) obtained by dividing a predetermined area including a forecasting target area into a plurality of grids and including weather data observed for each of the divided grids; the nonuniform grid constructing unit 4 that subdivides a predetermined grid among the grids indicated by the grid data acquired by the observation data acquiring unit 2, combines a predetermined grid among the grids indicated by the grid data with a grid adjacent to the grid, and generates nonuniform grid data indicating a nonuniform grid in which the subdivided grid and the combined grid are mixed and including weather data for each of the grids; and the nonuniform grid forecast processing unit 5 that forecasts weather data of the forecasting target area included in the predetermined area using the nonuniform grid data generated by the nonuniform grid constructing unit 4. As a result, the weather forecasting device 1 according to the first embodiment can improve forecasting accuracy of a weather condition while suppressing an increase in processing load as compared with related art.

In addition, the nonuniform grid constructing unit 4 generates the adjacent grid determining data D3 indicating an adjacency relationship between grids in the nonuniform grid, and the nonuniform grid forecast processing unit 5 specifies a set of grids having a nonuniform adjacency relationship from the nonuniform grid indicated by the nonuniform grid data on the basis of the adjacent grid determining data D3 generated by the nonuniform grid constructing unit 4, performs interpolation processing on the specified set of grids, and then performs forecast. As a result, the weather forecasting device 1 according to the first embodiment can accurately perform weather forecast using the nonuniform grid data.

In addition, the nonuniform grid constructing unit 4 subdivides a grid including the forecasting target area among the grids indicated by the grid data, and combines a grid including an area in which a temporal change of weather data is poor with a grid adjacent to the grid. As a result, the weather forecasting device 1 according to the first embodiment can perform weather forecast in the forecasting target area with high accuracy while suppressing an increase in processing load as the entire forecast processing.

In addition, the nonuniform grid constructing unit 4 subdivides a grid including an area in which a weather element that affects weather forecast in the forecasting target area can occur among the grids indicated by the grid data. As a result, the weather forecasting device 1 according to the first embodiment can accurately reflect an influence of a weather element occurring in the area in the forecasting target area, and can further improve accuracy of the weather forecast in the forecasting target area.

In addition, the weather forecasting device 1 includes the divided setting value data acquiring unit 3 that acquires conversion target data (divided setting value data) D2 including data indicating a subdividing target grid to be subdivided and data indicating a combining target grid to be combined with an adjacent grid among the grids indicated by the grid data. The nonuniform grid constructing unit 4 performs subdivision and combination on the basis of the conversion target data D2 acquired by the divided setting value data acquiring unit 3. As a result, the weather forecasting device 1 according to the first embodiment can accurately perform subdivision and combination of a grid.

In addition, the nonuniform grid constructing unit 4 includes the area selecting unit 41 that selects a subdividing target grid and a combining target grid from grids indicated by the grid data on the basis of the conversion target data acquired by the divided setting value data acquiring unit 3, and the selected area grid converting unit 42 that generates nonuniform grid data by subdividing the subdividing target grid selected by the area selecting unit 41 and combining the combining target grid selected by the area selecting unit 41 with a grid adjacent to the grid. As a result, the weather forecasting device 1 according to the first embodiment can appropriately select the subdividing target grid and the combining target grid and generate the nonuniform grid data.

In addition, the selected area grid converting unit 42 supplements weather data in a subdivided or combined grid, and the nonuniform grid forecast processing unit 5 performs forecast using the nonuniform grid data after the weather data is supplemented by the selected area grid converting unit 42. As a result, the weather forecasting device 1 according to the first embodiment can perform weather forecast in the forecasting target area with high accuracy on the basis of the supplemented weather data.

The selected area grid converting unit 42 supplements the weather data in the subdivided or combined grid by performing interpolation on the basis of weather data in a grid adjacent to the subdivided or combined grid. As a result, the weather forecasting device 1 according to the first embodiment can easily supplement the weather data in the subdivided or combined grid.

In addition, the selected area grid converting unit 42 supplements the weather data in the subdivided or combined grid by instructing the observation data acquiring unit 2 to acquire the weather data in the subdivided or combined grid. As a result, the weather forecasting device 1 according to the first embodiment can easily supplement the weather data in the subdivided or combined grid.

### Second Embodiment

In the first embodiment, the weather forecasting device that forecasts weather data of a forecasting target area included in a predetermined area using nonuniform grid data in which a subdivided grid and a combined grid are mixed has been described. In a second embodiment, a weather forecasting device that forecasts weather data of a forecasting target area included in a predetermined area in a case where not only the predetermined area but also a surrounding area thereof is used as an observation target of the weather data will be described.

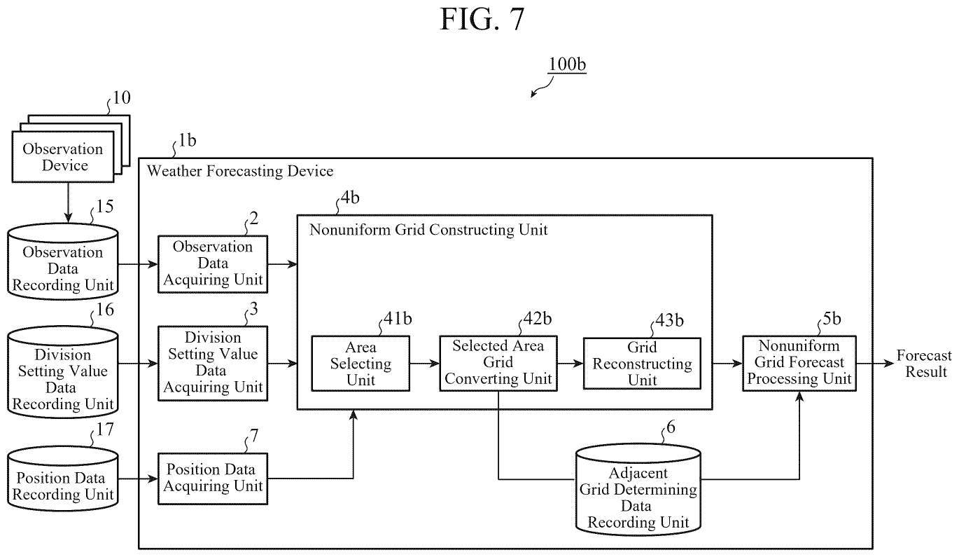

FIG. 7 is a diagram illustrating a configuration example of a weather forecasting system 100b including a weather forecasting device 1b according to the second embodiment. The weather forecasting system 100b according to the second embodiment is different from the weather forecasting system 100 according to the first embodiment illustrated in FIG. 1 in that a plurality of observation devices 10 is arranged and a position data recording unit 17 is added.

In addition, the weather forecasting device 1b according to the second embodiment is different from the weather forecasting device 1 according to the first embodiment illustrated in FIG. 1 in that a position data acquiring unit 7 (third acquisition unit) is added, the nonuniform grid constructing unit 4 is changed to a nonuniform grid constructing unit 4b, and the nonuniform grid forecast processing unit 5 is changed to a nonuniform grid forecast processing unit 5b. Note that each component of the nonuniform grid constructing unit 4b is expressed by adding “b” to an end of a reference numeral.

Since the other components of the weather forecasting system 100b and the weather forecasting device 1b according to the second embodiment are the same as those of the weather forecasting system 100 and the weather forecasting device 1 according to the first embodiment illustrated in FIG. 1, the same reference numerals are given, and description thereof is omitted.

As in the first embodiment, the observation device 10 observes a weather condition (weather data) in a predetermined area including an area to be subjected to weather forecast (forecasting target area). In the second embodiment, a plurality of the observation devices 10 is arranged, and one of the observation devices 10 observes a weather condition in a predetermined area (hereinafter, also referred to as a “reference area”) including the forecasting target area. In addition, another observation device 10 observes a weather condition in a predetermined area (hereinafter, also referred to as a “surrounding area”) other than the reference area. Note that the reference area and the surrounding area are, for example, adjacent (continuous) areas.

Each of the observation devices 10 observes a weather condition in an area to be observed, for example, at a time set in advance, and generates observation data D1. As in the first embodiment, the observation data D1 is, for example, grid data obtained by dividing the reference area or the surrounding area into a plurality of grids, and the grid data includes weather data observed for each of the grids. Each of the observation devices 10 causes an observation data recording unit 15 to record the generated observation data D1.

A divided setting value data recording unit 16 records divided setting value data D2. In the second embodiment, the divided setting value data D2 is generated for each of the reference area and the surrounding area, for example, by a user and is recorded in the divided setting value data recording unit 16.

The position data recording unit 17 is constituted by a recording medium such as a hard disk drive (HDD) or a solid state drive (SSD). The position data recording unit 17 records position data D4.

The position data D4 indicates the position of each of the reference area and the surrounding area. For example, in a case where each of the reference area and the surrounding area is an area divided in a rectangular shape, the position data D4 includes data indicating the latitude and longitude of a center point of the area divided in a rectangular shape and the latitudes and longitudes of four corner points of the area divided in a rectangular shape. The position data D4 is generated in advance by the user and recorded in the position data recording unit 17. Note that the position data D4 described here is merely an example, and the position data D4 may include data other than the above as long as the data indicates the position of each of the reference area and the surrounding area.

The position data acquiring unit 7 acquires the position data D4 from the position data recording unit 17. The position data acquiring unit 7 outputs the acquired position data D4 to the nonuniform grid constructing unit 4b.

The nonuniform grid constructing unit 4b acquires the observation data D1 for each of the reference area and the surrounding area from the observation data acquiring unit 2. In addition, the nonuniform grid constructing unit 4b acquires the divided setting value data D2 for each of the reference area and the surrounding area from a divided setting value data acquiring unit 3. Then, for each piece of the observation data D1, by subdividing a predetermined grid among grids indicated by the observation data D1 (grid data) and combining a predetermined grid among the grids indicated by the observation data D1 with a grid adjacent to the grid, the nonuniform grid constructing unit 4b generates nonuniform grid data indicating a nonuniform grid in which the subdivided grid and the combined grid are mixed. At this time, the nonuniform grid constructing unit 4b selects a subdividing target grid and a combining target grid in a corresponding area on the basis of the divided setting value data D2 for each of the reference area and the surrounding area, acquired from the divided setting value data acquiring unit 3. In addition, the nonuniform grid constructing unit 4b generates nonuniform grid data on the basis of the position data D4 acquired from the position data acquiring unit 7.

An area selecting unit 41b selects a subdividing target grid and a combining target grid from grids indicated by the observation data D1 in a corresponding area on the basis of the divided setting value data D2 for each of the reference area and the surrounding area. The area selecting unit 41b outputs data indicating the selected result to a selected area grid converting unit 42b.

The selected area grid converting unit 42b acquires data indicating the selection result from the area selecting unit 41b. As in the first embodiment, the selected area grid converting unit 42b performs grid conversion (subdivision and combination) for each of the reference area and the surrounding area on the basis of the acquired data. The selected area grid converting unit 42b outputs data indicating a result of the grid conversion to a grid reconstructing unit 43b.

In addition, the selected area grid converting unit 42b generates adjacent grid determining data D3 indicating an adjacency relationship between grids in the observation data D1 (grid data) after the grid conversion for each of the reference area and the surrounding area. In addition, the selected area grid converting unit 42b causes the adjacent grid determining data recording unit 6 to record the generated adjacent grid determining data D3 for each of the reference area and the surrounding area.

The grid reconstructing unit 43b acquires data indicating a result of the grid conversion from the selected area grid converting unit 42b. The grid reconstructing unit 43b constructs a grid (nonuniform grid) in which the subdivided grid and the combined grid are mixed on the basis of the acquired data for each of the reference area and the surrounding area, and generates data (nonuniform grid data) indicating the nonuniform grid. In addition, the grid reconstructing unit 43b combines the nonuniform grid data generated for the reference area and the nonuniform grid data generated for the surrounding area on the basis of the position data D4, and generates nonuniform grid data (hereinafter, also referred to as “extended nonuniform grid data”) related to an area obtained by joining the reference area and the surrounding area. The grid reconstructing unit 43b outputs the generated extended nonuniform grid data to the nonuniform grid forecast processing unit 5b.

The nonuniform grid forecast processing unit 5b acquires the extended nonuniform grid data from the grid reconstructing unit 43b, and forecasts weather data of a forecasting target area included in the reference area using the acquired extended nonuniform grid data and the adjacent grid determining data D3 for each of the reference area and the surrounding area, recorded in the adjacent grid determining data recording unit 6. Then, the nonuniform grid forecast processing unit 5b outputs the forecasted weather data of the forecasting target area as a forecast result.

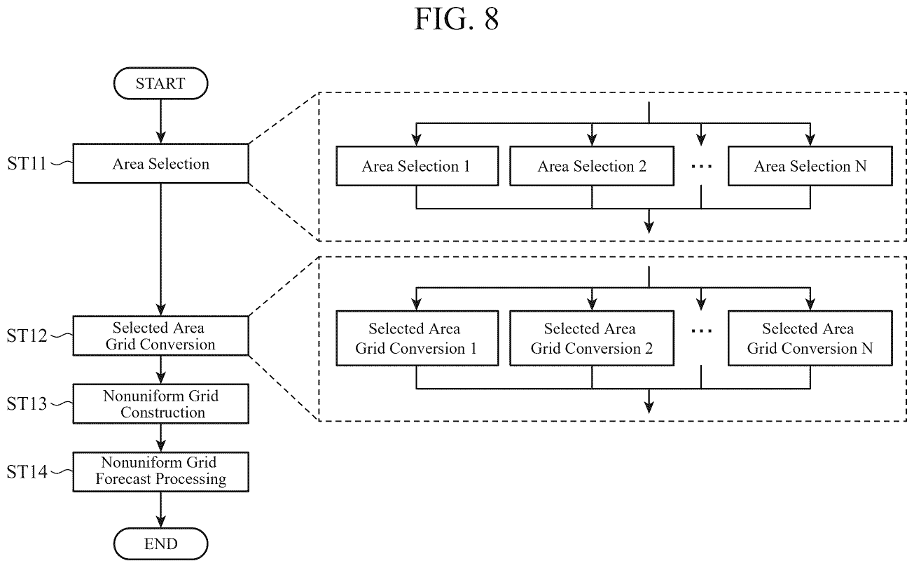

Next, an operation example of the weather forecasting device 1b according to the second embodiment will be described with reference to the flowchart illustrated in FIG. 8.

First, the area selecting unit 41b of the nonuniform grid constructing unit 4b selects a subdividing target grid and a combining target grid from grids indicated by the observation data D1 in a corresponding area on the basis of the divided setting value data D2 for each of the reference area and the surrounding area (step ST11). Note that the area selecting unit 41b may perform this selection in parallel for each of the reference area and the surrounding areas as illustrated in a dotted frame illustrated in FIG. 8.

Next, the selected area grid converting unit 42b performs grid conversion on the grid selected by the area selecting unit 41b for each of the reference area and the surrounding area (step ST12). Note that the selected area grid converting unit 42b may perform this grid conversion in parallel for each of the reference area and the surrounding area as indicated in a dotted frame illustrated in FIG. 8.

Next, the grid reconstructing unit 43b constructs a nonuniform grid for each of the reference area and the surrounding area on the basis of the data indicating the result of the grid conversion, acquired from the selected area grid converting unit 42b, and generates nonuniform grid data. In addition, the grid reconstructing unit 43b combines the nonuniform grid data generated for the reference area and the nonuniform grid data generated for the surrounding area on the basis of the position data D4, and generates extended nonuniform grid data related to an area obtained by joining the reference area and the surrounding area (step ST13).

Next, the nonuniform grid forecast processing unit 5b acquires the extended nonuniform grid data from the grid reconstructing unit 43b, and forecasts weather data of a forecasting target area included in the reference area using the acquired extended nonuniform grid data and the adjacent grid determining data D3 for each of the reference area and the surrounding area, recorded in the adjacent grid determining data recording unit 6 (step ST14).

As described above, the weather forecasting device 1b according to the second embodiment can use pieces of observation data obtained by the observation devices 10 that observe different areas in combination. Therefore, the weather forecasting device 1b can perform weather forecast in a forecasting target area with high accuracy while efficiently considering observation data observed in a wider area.

As described above, according to the second embodiment, the observation data acquiring unit 2 acquires the grid data D1 obtained by dividing a predetermined area including a forecasting target area into a plurality of grids and the grid data D1 obtained by dividing a surrounding area other than the predetermined area into a plurality of grids, the nonuniform grid constructing unit 4b generates extended nonuniform grid data indicating a nonuniform grid related to an area obtained by joining the predetermined area and the surrounding area and including weather data for each of the grids on the basis of the grid data D1 for each of the predetermined area and the surrounding area, acquired by the observation data acquiring unit 2, and the nonuniform grid forecast processing unit 5b performs forecast using the extended nonuniform grid data generated by the nonuniform grid constructing unit 4b. As a result, in addition to the effects of the first embodiment, the weather forecasting device 1b according to the second embodiment can perform weather forecast in a forecasting target area with high accuracy while efficiently considering observation data observed in a wider area.

In addition, the weather forecasting device 1b includes the position data acquiring unit 7 that acquires the position data D4 indicating the positions of the predetermined area and the surrounding area, and the nonuniform grid constructing unit 4b generates the extended nonuniform grid data on the basis of the position data D4 acquired by the position data acquiring unit 7. As a result, in addition to the effects of the first embodiment, the weather forecasting device 1b according to the second embodiment can accurately generate the extended nonuniform grid data.

### Third Embodiment

In the first embodiment, the weather forecasting device that forecasts weather data of a forecasting target area included in a predetermined area using nonuniform grid data in which a subdivided grid and a combined grid are mixed has been described. In a third embodiment, a weather forecasting device capable of determining whether or not a forecast result indicated by forecasted weather data ensures predetermined accuracy will be described.

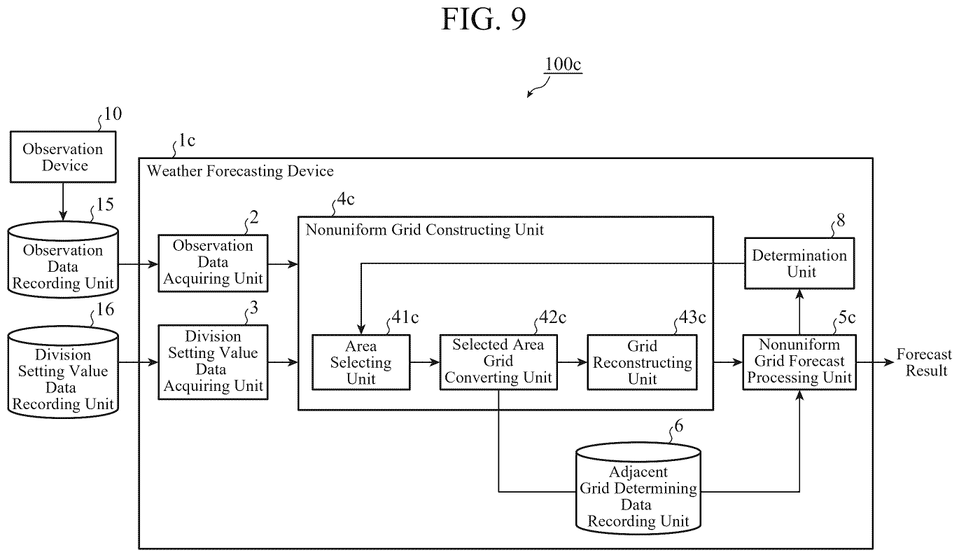

FIG. 9 is a diagram illustrating a configuration example of a weather forecasting system 100c including a weather forecasting device 1c according to the third embodiment. The weather forecasting device 1c according to the third embodiment is different from the weather forecasting device 1 according to the first embodiment illustrated in FIG. 1 in that a determination unit 8 is added, the nonuniform grid constructing unit 4 is changed to a nonuniform grid constructing unit 4c, and the nonuniform grid forecast processing unit 5 is changed to a nonuniform grid forecast processing unit 5c. Note that each component of the nonuniform grid constructing unit 4c is expressed by adding “c” to an end of a reference numeral. Since the other components of the weather forecasting system 100c and the weather forecasting device 1c according to the third embodiment are the same as those of the weather forecasting system 100 and the weather forecasting device 1 according to the first embodiment illustrated in FIG. 1, the same reference numerals are given, and description thereof is omitted.

The nonuniform grid forecast processing unit 5c outputs forecasted weather data (hereinafter, also referred to as “forecast data”) of a forecasting target area to the determination unit 8 before outputting the weather data to the outside.

The determination unit 8 acquires the forecast data from the nonuniform grid forecast processing unit 5c. Then, the determination unit 8 determines whether or not a forecast result indicated by the forecast data ensures the predetermined accuracy on the basis of the acquired forecast data.

The determination unit 8 performs the determination in this case, for example, as follows. For example, the determination unit 8 acquires forecast data indicating a forecast result at any future time (for example, 200 seconds later) from the nonuniform grid forecast processing unit 5c. In addition, the determination unit 8 acquires weather data (hereinafter, also referred to as “actual measurement data”) of the forecasting target area actually observed by an observation device 10 at the above time (for example, 200 seconds later). In this case, for example, the determination unit 8 may directly acquire the actual measurement data from the observation device 10, or may instruct an observation data acquiring unit 2 to acquire the actual measurement data from the observation device 10 and acquire the actual measurement data acquired by the observation data acquiring unit 2.

Then, the determination unit 8 calculates a matching ratio between the forecast data and the actual measurement data, and when the calculated matching ratio is equal to or more than a threshold, the determination unit 8 determines that the forecast result indicated by the forecast data ensures the predetermined accuracy. Meanwhile, when the calculated matching ratio is less than the threshold, the determination unit 8 determines that the forecast result indicated by the forecast data does not ensure the predetermined accuracy. Note that, for example, this threshold only needs to be set in advance by a user and recorded in a divided setting value data recording unit 16.

When the determination unit 8 determines that the forecast result indicated by the forecast data ensures the predetermined accuracy, the determination unit 8 notifies the nonuniform grid forecast processing unit 5c of the determination result. Meanwhile, when the determination unit 8 determines that the forecast result indicated by the forecast data does not ensure the predetermined accuracy, the determination unit 8 notifies the nonuniform grid forecast processing unit 5c of the determination result, and instructs the nonuniform grid constructing unit 4c to reconstruct the nonuniform grid and regenerate the nonuniform grid data.

When receiving this instruction, an area selecting unit 41c of the nonuniform grid constructing unit 4c refers to grids selected as subdividing target grids in the previous forecast, and determines whether or not at least one of the grids can be further subdivided.

Note that this determination is performed, for example, as follows. For example, a user sets in advance the maximum number of times that one grid can be subdivided, and records data indicating the maximum number of times in the divided setting value data recording unit 16. Then, when the number of times of subdivision of a grid selected as a subdividing target grid in the previous forecast does not reach the maximum number of times, the area selecting unit 41c determines that the grid can be further subdivided.

Alternatively, the user sets in advance a minimum area that can be taken by one grid, and records data indicating the minimum area in the divided setting value data recording unit 16. Then, when the area of a grid selected as a subdividing target grid in the previous forecast is larger than the minimum area, the area selecting unit 41c determines that the grid can be further subdivided.

Then, when determining that at least one of grids selected as subdividing target grids can be further subdivided, the area selecting unit 41c outputs data indicating the determination result to a selected area grid converting unit 42c. Meanwhile, when all the grids selected as subdividing target grids cannot be further subdivided, the area selecting unit 41c notifies the nonuniform grid forecast processing unit 5c of the fact. When acquiring data indicating that at least one of grids selected as

subdividing target grids can be further subdivided from the area selecting unit 41c, the selected area grid converting unit 42c further subdivides the grid by a similar method to that in the first embodiment. The selected area grid converting unit 42c outputs data indicating a result of the subdivision to a grid reconstructing unit 43c. In addition, the selected area grid converting unit 42c generates adjacent grid determining data D3 indicating an adjacency relationship between grids in the observation data D1 (grid data) after the subdivision, and causes the adjacent grid determining data recording unit 6 to record the generated adjacent grid determining data D3.

The grid reconstructing unit 43c constructs a nonuniform grid in which the subdivided grid and the combined grid are mixed, and generates nonuniform grid data indicating the nonuniform grid in a similar manner to the first embodiment. Then, the nonuniform grid forecast processing unit 5c performs forecast again using the generated nonuniform grid data, and outputs forecast data obtained as a result to the determination unit 8. The determination unit 8 determines whether or not a forecast result indicated by the forecast data ensures the predetermined accuracy in a similar flow to the above.

Note that when being notified of a fact that the forecast result indicated by the forecast data ensures the predetermined accuracy by the determination unit 8, the nonuniform grid forecast processing unit 5c outputs the forecast result to the outside. In addition, when being notified of a fact that all the grids selected as the subdividing target grids cannot be further subdivided by the area selecting unit 41c, the nonuniform grid forecast processing unit 5c may output the fact and the fact that the forecast result indicated by the forecast data does not ensure the predetermined accuracy together to the outside.

Note that, in the weather forecasting device 1c, the output of the forecast data from the nonuniform grid forecast processing unit 5c to the determination unit 8 and the determination by the determination unit 8 may be repeatedly performed. In this case, the number of repetitions may be, for example, set in advance by the user and may be recorded in the divided setting value data recording unit 16.

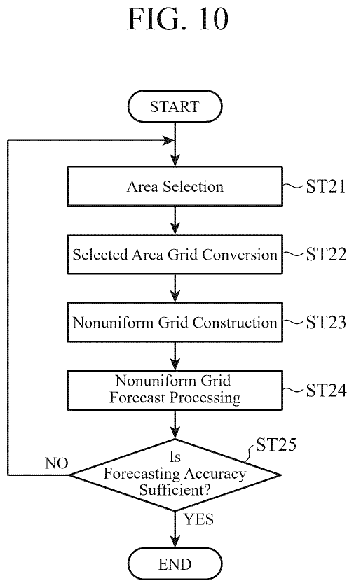

Next, an operation example of the weather forecasting device 1c according to the third embodiment will be described with reference to the flowchart illustrated in FIG. 10. Note that steps ST21 to ST23 of the flowchart illustrated in FIG. 10 are similar to steps ST01 to ST03 of the flowchart illustrated in FIG. 2, and thus, repeated description thereof is omitted.

In step ST24, the nonuniform grid forecast processing unit 5c forecasts weather data in the forecasting target area using the nonuniform grid data, and outputs forecast data obtained by the forecast to the determination unit 8.

In step ST25, the determination unit 8 acquires forecast data from the nonuniform grid forecast processing unit 5c, and determines whether or not a forecast result indicated by the acquired forecast data ensures the predetermined accuracy (step ST25). As a result, if the determination unit 8 determines that the forecast result indicated by the forecast data ensures the predetermined accuracy (step 25; YES), the nonuniform grid forecast processing unit 5c outputs the forecast result indicated by the forecast data and ends the processing. Meanwhile, if the determination unit 8 determines that the forecast result indicated by the forecast data does not ensure the predetermined accuracy (step 25; NO), the determination unit 8 instructs the nonuniform grid constructing unit 4c to reconstruct the nonuniform grid and regenerate the nonuniform grid data. Thereafter, the process returns to step ST21, and the area selecting unit 41c performs area selection again (selection of a subdividing target grid that can be further subdivided). Thereafter, the weather forecasting device 1c repeats the processing of steps ST21 to ST25 until it is determined in step ST25 that the forecast result indicated by the forecast data ensures the predetermined accuracy.

As described above, the weather forecasting device 1c according to the third embodiment performs forecast processing by reconstructing the nonuniform grid and regenerating the nonuniform grid data when a forecast result that ensures the predetermined accuracy cannot be obtained as a result of forecast processing using the nonuniform grid. As a result, the weather forecasting device 1c can avoid outputting a forecast result for which the predetermined accuracy is not obtained, and can output a forecast result with higher accuracy.

As described above, according to the third embodiment, the weather forecasting device 1c includes the determination unit 8 that determines whether or not a forecast result indicated by weather data forecasted by the nonuniform grid forecast processing unit 5c ensures predetermined accuracy, and the determination unit 8 instructs the nonuniform grid constructing unit 4c to regenerate nonuniform grid data when determining that the forecast result does not ensure the predetermined accuracy, and when receiving the instruction, the nonuniform grid constructing unit 4c regenerates the nonuniform grid data by subdividing a grid that can be further subdivided among subdivided grids included in the nonuniform grid. As a result, in addition to the effects of the first embodiment, the weather forecasting device 1c according to the third embodiment can avoid outputting a forecast result for which the predetermined accuracy is not obtained, and can output a forecast result with higher accuracy.

In addition, the determination unit 8 calculates a matching ratio between weather data indicating a forecast result at any future time, forecasted by the nonuniform grid forecast processing unit 5c and weather data actually observed in a forecasting target area at the time, and determines that the forecast result does not ensure the predetermined accuracy when the calculated matching ratio is less than a threshold. As a result, in addition to the effects of the first embodiment, the weather forecasting device 1c according to the third embodiment can accurately determine whether or not the forecast result ensures the predetermined accuracy.

### Fourth Embodiment

In the first embodiment, the weather forecasting device that forecasts weather data of a forecasting target area included in a predetermined area using nonuniform grid data in which a subdivided grid and a combined grid are mixed has been described. In a fourth embodiment, a weather forecasting device capable of performing forecast related to rainfall and wind in a forecasting target area with higher accuracy will be described.

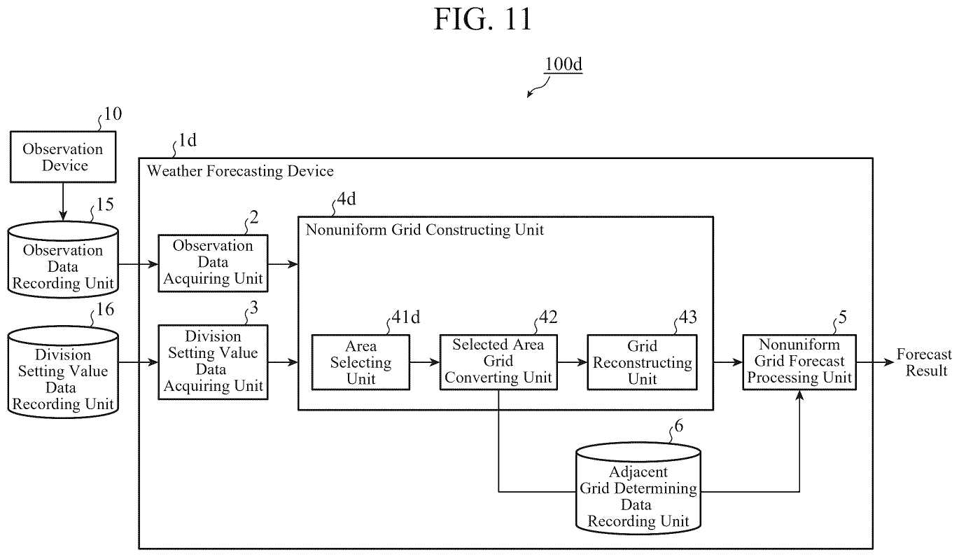

FIG. 11 is a diagram illustrating a configuration example of a weather forecasting system 100d including a weather forecasting device 1d according to the fourth embodiment. The weather forecasting device 1d according to the fourth embodiment is different from the weather forecasting device 1 according to the first embodiment illustrated in FIG. 1 in that the area selecting unit 41 is changed to an area selecting unit 41d, and the nonuniform grid constructing unit 4 is changed to a nonuniform grid constructing unit 4d. Since the other components of the weather forecasting system 100d and the weather forecasting device 1d according to the fourth embodiment are the same as those of the weather forecasting system 100 and the weather forecasting device 1 according to the first embodiment illustrated in FIG. 1, the same reference numerals are given, and description thereof is omitted.

As in the first embodiment, the area selecting unit 41d selects a subdividing target grid and a combining target grid from grids indicated by observation data D1 on the basis of divided setting value data D2.

In addition, after the above selection, the area selecting unit 41d refers to the grids indicated by the observation data D1 one by one, and determines whether or not a wind speed and a humidity indicated by weather data in each of the grids are equal to or more than thresholds. Then, the area selecting unit 41d additionally selects a grid for which it is determined that the wind speed and the humidity are equal to or more than the thresholds as a subdividing target grid. Note that when the grid for which it is determined that the wind speed and the humidity are equal to or more than the thresholds is already selected as a subdividing target grid on the basis of the divided setting value data D2, the area selecting unit 41d maintains the selection.

Meanwhile, the area selecting unit 41d does not additionally select a grid for which it is determined that the wind speed and the humidity are not equal to or more than the thresholds as a subdividing target grid. Note that when the grid for which it is determined that the wind speed and the humidity are not equal to or more than the thresholds is already selected as a subdividing target grid on the basis of the divided setting value data D2, the area selecting unit 41d may maintain the selection, or may cancel the selection in consideration of a processing load. Thereafter, the area selecting unit 41d outputs data indicating the selected result to the selected area grid converting unit 42. Note that, for example, the thresholds related to the wind speed and the humidity only need to be set in advance by a user and recorded in a divided setting value data recording unit 16.

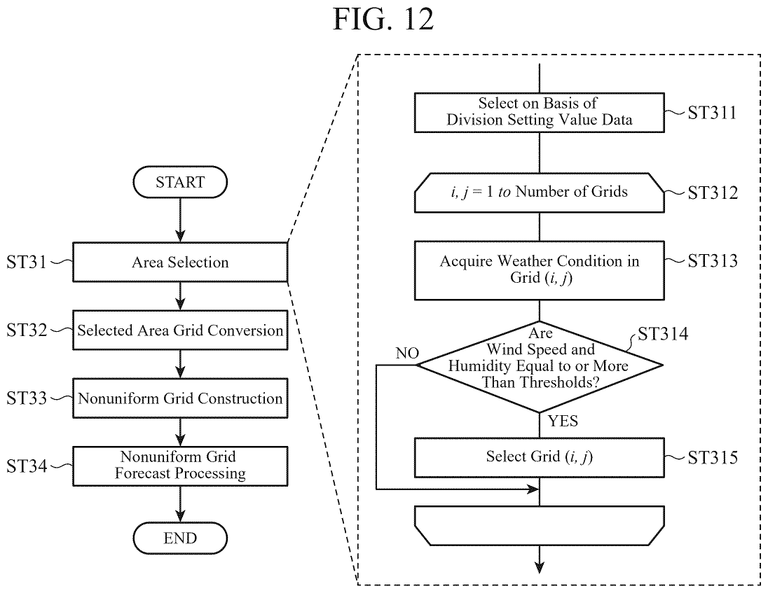

Next, an operation example of the weather forecasting device 1d according to the fourth embodiment will be described with reference to the flowchart illustrated in FIG. 12.

First, the area selecting unit 41d of the nonuniform grid constructing unit 4d selects a subdividing target grid and a combining target grid (step ST31).

For example, as illustrated in a dotted frame in FIG. 12, the area selecting unit 41d selects a subdividing target grid and a combining target grid from grids indicated by the observation data D1 on the basis of the divided setting value data D2 (step ST311).

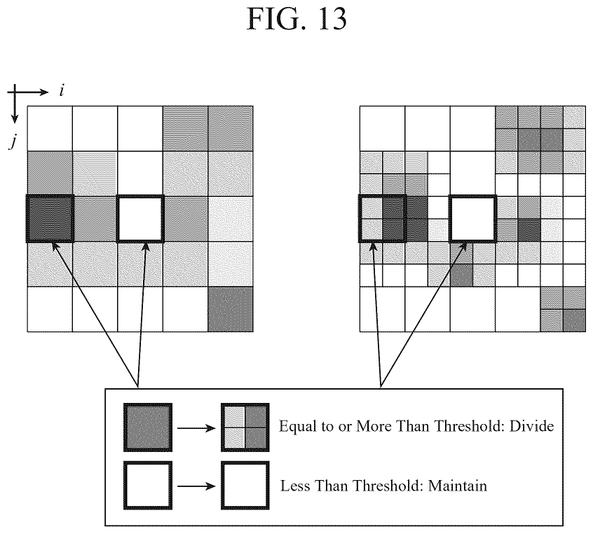

Next, after the selection in step ST311, the area selecting unit 41d refers to the grids indicated by the observation data D1 one by one (step ST312). For example, as illustrated in FIG. 13, when each of the grids is expressed by (i, j), the area selecting unit 41d refers to the grids one by one while counting up i and j from 1. Note that i is a variable indicating the position of each grid in the east-west direction (left-right direction), and j is a variable indicating the position of each grid in the north-south direction (up-down direction).

Then, the area selecting unit 41d acquires weather data (weather condition) in a grid (i, j) (step ST313).

Next, the area selecting unit 41d determines whether or not a wind speed and a humidity indicated by the weather data in the grid (i, j) are equal to or more than thresholds (step ST314). As a result, if the area selecting unit 41d determines that the wind speed and the humidity are equal to or more than the thresholds (step ST314; YES), the area selecting unit 41d additionally selects the grid (i, j) as a subdividing target grid (step ST315). Meanwhile, if the area selecting unit 41d determines that the wind speed and the humidity are not equal to or more than the thresholds (step ST314; NO), the area selecting unit 41d does not additionally select the grid (i, j) as a subdividing target grid. Thereafter, the process returns to step ST312, and then the area selecting unit 41d repeats steps ST312 to ST315 for each of the grids.

When step ST31 ends, the process proceeds to step ST32. Note that steps ST32 to ST34 are similar to steps ST2 to ST4 of the flowchart illustrated in FIG. 2, and thus, repeated description thereof is omitted. Note that the grid additionally selected as a subdividing target grid is subdivided by the selected area grid converting unit 42b in step ST32, for example, as illustrated in FIG. 13, but for the other grids, for example, previous selection results are maintained.

As described above, the weather forecasting device 1d according to the fourth embodiment additionally selects a grid for which it is determined that a wind speed and a humidity are equal to or more than thresholds as a subdividing target grid, separately from the selection based on the divided setting value data D2. This is based on, for example, a fact that an influence of the wind speed and humidity on forecast is considered to be particularly strong in forecasting rainfall and wind in a forecasting target area.

For example, when attention is paid to the rainfall, a humidity, more strictly speaking, a weather element of a water vapor mixing amount in the sky strongly affects presence or absence of rainfall and a rainfall amount. Regarding the wind, a wind direction and the like can also be determined by a wind speed (wind strength). Therefore, in the weather forecasting device 1d, as described above, a grid whose wind speed and humidity are equal to or more than thresholds is additionally selected as a subdividing target grid, separately from the selection based on the divided setting value data D2. As a result, the weather forecasting device 1d can perform forecast related to rainfall and wind in the forecasting target area with higher accuracy.

Note that, in the above description, an example has been described in which the area selecting unit 41d selects a subdividing target grid and a combining target grid on the basis of the divided setting value data D2, and then additionally selects a subdividing target grid by referring to the grids one by one. However, the area selecting unit 41d is not limited thereto, and for example, may perform only the selection of a subdividing target grid based on the wind speed and the humidity by omitting the selection of a subdividing target grid based on the divided setting value data D2.

In addition, in the above description, an example has been described in which the area selecting unit 41d additionally selects a subdividing target grid on the basis of the wind speed and the humidity. However, the area selecting unit 41d is not limited thereto, and for example, may use atmospheric pressure as a determination element of the selection in addition to the wind speed and the humidity. This is generally based on a fact that the atmospheric pressure is said to be a significant weather element in weather forecast. For example, rainfall and wind speed are easily affected by the atmospheric pressure, and depending on a relationship with the atmospheric pressure, a typhoon, torrential rain, and the like may occur. Therefore, the area selecting unit 41d can perform forecast related to the rainfall and the wind in a forecasting target area with higher accuracy by using the atmospheric pressure as a determination element of the selection in addition to the wind speed and the humidity.

As described above, according to the fourth embodiment, the nonuniform grid constructing unit 4d subdivides a grid in which a wind speed and a humidity indicated by weather data in the grid are equal to or more than thresholds among grids indicated by the grid data D1 acquired by the observation data acquiring unit 2. As a result, in addition to the effects of the first embodiment, the weather forecasting device 1d according to the fourth embodiment can perform forecast related to rainfall and wind in the forecasting target area with higher accuracy.

### Fifth Embodiment

In the first embodiment, the weather forecasting system including one weather forecasting device has been described. In a fifth embodiment, a weather forecasting system capable of speeding up forecast processing by parallel processing by two weather forecasting devices will be described.

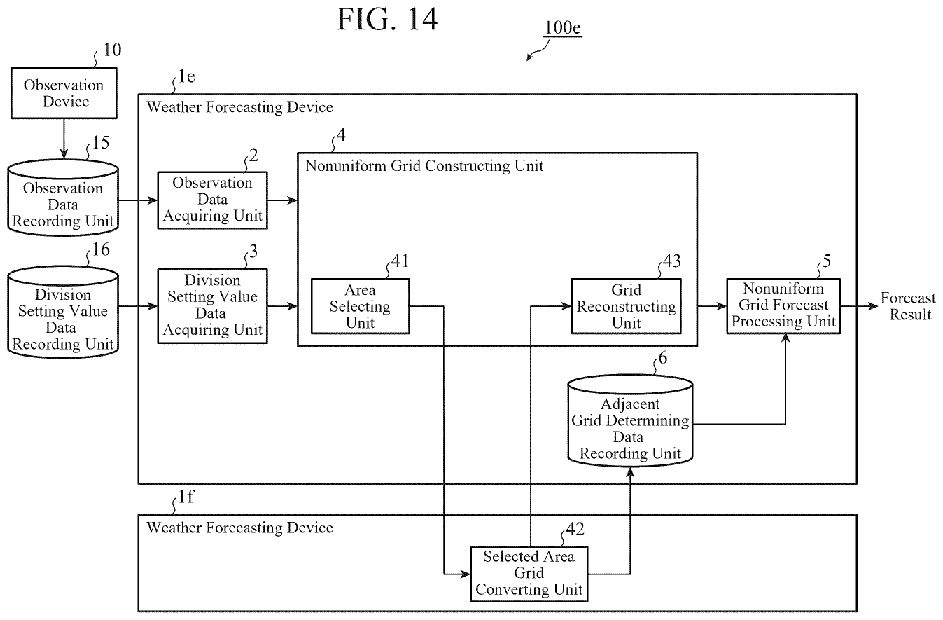

FIG. 14 is a diagram illustrating a configuration example of a weather forecasting system 100e including a weather forecasting device 1e (first weather forecasting device) and a weather forecasting device 1f (second weather forecasting device) according to the fifth embodiment. The weather forecasting system 100e according to the fifth embodiment is different from the weather forecasting system 100 according to the first embodiment illustrated in FIG. 1 in that the weather forecasting device 1 is changed to the weather forecasting device 1e and the weather forecasting device 1f is added.

Note that the weather forecasting device 1e according to the fifth embodiment is obtained by removing the selected area grid converting unit 42 from the weather forecasting device 1 according to the first embodiment, and the weather forecasting device 1f according to the fifth embodiment includes the selected area grid converting unit 42. Since the other components of the weather forecasting system 100e and the weather forecasting device 1e according to the fifth embodiment are the same as those of the weather forecasting system 100 and the weather forecasting device 1 according to the first embodiment illustrated in FIG. 1, the same reference numerals are given, and description thereof is omitted.

In the weather forecasting system 100e, as illustrated in FIG. 14, the weather forecasting device 1e and the weather forecasting device 1f are communicably connected to each other via a network (not illustrated). In addition, in the weather forecasting system 100e, the weather forecasting device 1e serves as a main processing device responsible for main processing in weather forecast processing, and the weather forecasting device 1f serves as an external processing device that is located outside the main processing device and mainly performs a grid conversion process.

Note that the weather forecasting device 1e and the weather forecasting device If may have almost the same level of calculation performance, but in addition to this, for example, the weather forecasting device 1f that is an external processing device may have higher calculation performance than the weather forecasting device 1e that is a main processing device. For example, the weather forecasting device 1e may include a central processing unit (CPU), and the weather forecasting device 1f may include a graphics processing unit (GPU) or a field programmable gate array (FPGA).

Note that, in the weather forecasting system 100e, as a premise, the weather forecasting device 1e performs transfer of grid data to be subjected to grid conversion to the weather forecasting device 1f, management of a result of processing performed by the weather forecasting device 1f, and the like, and the weather forecasting device 1f mainly performs grid conversion on the grid data transferred from the weather forecasting device 1e.

Next, an operation example of the weather forecasting system 100e according to the fifth embodiment will be described. First, as in the first embodiment, an area selecting unit 41 of the weather forecasting device 1e selects a subdividing target grid and a combining target grid from grids indicated by observation data D1 on the basis of divided setting value data D2. The area selecting unit 41 transmits data indicating the selected result together with the observation data D1 to the selected area grid converting unit 42 of the weather forecasting device 1f via the network.

When receiving the data indicating the selection result and the observation data D1 transmitted from the area selecting unit 41, the selected area grid converting unit 42 of the weather forecasting device 1f performs grid conversion (subdivision and combination) on the basis of the data indicating the selection result. Then, the selected area grid converting unit 42 transmits data indicating a result of the grid conversion to the grid reconstructing unit 43 of the weather forecasting device 1e via the network.

In addition, the selected area grid converting unit 42 generates adjacent grid determining data D3 indicating an adjacency relationship between grids in the observation data D1 (grid data) after the grid conversion, and causes an adjacent grid determining data recording unit 6 of the weather forecasting device 1e to record the generated adjacent grid determining data D3 via the network.

When receiving data indicating a result of the grid conversion from the selected area grid converting unit 42, the grid reconstructing unit 43 of the weather forecasting device 1e constructs a nonuniform grid on the basis of the received data, and generates nonuniform grid data indicating the nonuniform grid. The grid reconstructing unit 43 outputs the generated nonuniform grid data to a nonuniform grid forecast processing unit 5.

When acquiring the nonuniform grid data from the grid reconstructing unit 43, the nonuniform grid forecast processing unit 5 of the weather forecasting device 1e forecasts weather data of a forecasting target area included in a predetermined area using the acquired nonuniform grid data and the adjacent grid determining data D3 recorded in the adjacent grid determining data recording unit 6. Then, the nonuniform grid forecast processing unit 5 outputs the forecasted weather data of the forecasting target area as a forecast result.

Here, pieces of the grid conversion processing performed by the selected area grid converting unit 42 of the weather forecasting device 1f on grids are independent of each other and can be performed in parallel. Therefore, as soon as the grid conversion processing for one grid is completed, the selected area grid converting unit 42 transmits data indicating a result of the grid conversion processing to the grid reconstructing unit 43 of the weather forecasting device 1e as needed while performing the grid conversion processing for each grid in parallel. In addition, when receiving the data indicating the result of the grid conversion from the selected area grid converting unit 42, the grid reconstructing unit 43 of the weather forecasting device 1e returns a grid indicated by the data to an original position thereof in the observation data D1 each time, combines the grid with another grid, and constructs a nonuniform grid. At this time, the grid conversion processing performed by the selected area grid converting unit 42 and the nonuniform grid constructing processing performed by the grid reconstructing unit 43 can be performed in parallel.

As described above, in the weather forecasting system 100e according to the fifth embodiment, the weather forecasting device 1e and the weather forecasting device If share processing necessary for constructing a nonuniform grid. As a result, in the weather forecasting system 100e, for example, the grid conversion processing and the nonuniform grid constructing processing can be performed in parallel, and the forecast processing can be sped up as compared with a case of using one weather forecasting device.

In addition, in this case, in the weather forecasting system 100e, when calculation performance of the weather forecasting device 1f is made superior to calculation performance of the weather forecasting device 1e, and the grid conversion processing with a larger processing load is performed by the weather forecasting device If, the grid conversion processing can be further sped up, and as a result, the forecast processing can be further sped up.

As described above, according to the fifth embodiment, the weather forecasting system 100e includes the weather forecasting device 1e and the weather forecasting device 1f communicably connected to each other, in which the weather forecasting device 1e includes: the observation data acquiring unit 2 that acquires the grid data D1 obtained by dividing a predetermined area including a forecasting target area into a plurality of grids and including weather data observed in each of the divided grids; the area selecting unit 41 that selects a grid to be subjected to grid conversion from grids indicated by the grid data and transmits data indicating the selected result to the weather forecasting device 1f; the grid reconstructing unit 43 that generates nonuniform grid data indicating a grid in which a subdivided grid and a combined grid are mixed on the basis of the data indicating a result of the grid conversion transmitted from the weather forecasting device 1f; and the nonuniform grid forecast processing unit 5 that forecasts weather data of the forecasting target area included in the predetermined area using the nonuniform grid data generated by the grid reconstructing unit 43, the weather forecasting device 1f includes the selected area grid converting unit 42 that performs grid conversion on the grid selected by the area selecting unit 41 and transmits data indicating a result of the grid conversion to the weather forecasting device 1e, and the processing performed by the selected area grid converting unit 42 and the processing performed by the grid reconstructing unit 43 are performed in parallel. As a result, the weather forecasting system 100e according to the fifth embodiment can improve forecasting accuracy of a weather condition as compared with related art while suppressing an increase in processing load, and can speed up forecast processing as compared with a case of using one weather forecasting device.

Note that the present disclosure can freely combine the embodiments to each other, modify any constituent element in each of the embodiments, or omit any constituent element in each of the embodiments.

### INDUSTRIAL APPLICABILITY

The present disclosure can improve forecasting accuracy of a weather condition as compared with related art while suppressing an increase in processing load, and is suitable for use in a weather forecasting device, a weather forecasting system, and a weather forecasting method.

### REFERENCE SIGNS LIST

1b, 1c, 1d, 1e, If: weather forecasting device, 2: observation data acquiring unit (first acquisition unit), 3: divided setting value data acquiring unit (second acquisition unit), 4, 4b, 4c, 4d: nonuniform grid constructing unit (generation unit), 5, 5b, 5c: nonuniform grid forecast processing unit (forecast processing unit), 6: adjacent grid determining data recording unit, 7: position data acquiring unit (third acquisition unit), 8: determination unit, 10: observation device, 15: observation data recording unit, 16: divided setting value data recording unit, 17: position data recording unit, 41, 41b, 41c, 41d: area selecting unit, 42, 42b, 42c: selected area grid converting unit, 43, 43b, 43c: grid reconstructing unit, 51: processing circuit, 52: CPU, 53: memory, 100, 100b, 100c, 100d, 100e: weather forecasting system, 506: graph, A1: local area, A2: middle area, A3: large area

1. A weather forecasting device comprising processing circuitry
to acquire grid data obtained by dividing a predetermined area including a forecasting target area into a plurality of grids and including weather data observed for each of the plurality of grids,
to perform subdivision of a predetermined grid among the plurality of grids indicated by the grid data to be subdivided grids, to perform combination of another predetermined grid among the plurality of grids indicated by the grid data with a grid adjacent to said another predetermined grid to be a combined gird, and to generate nonuniform grid data indicating nonuniform grids in which the subdivided grids and the combined grid are included and including weather data for each of the nonuniform grids, and
to perform forecast of weather data of the forecasting target area included in the predetermined area using the nonuniform grid data.

2. The weather forecasting device according to claim 1, wherein
the processing circuitry generates adjacent grid determining data indicating an adjacency relationship between grids in the nonuniform grids, and
the processing circuitry specifies a set of grids having a nonuniform adjacency relationship from the nonuniform grids indicated by the nonuniform grid data on a basis of the adjacent grid determining data, performs interpolation processing on the set of grids, and then performs the forecast.

3. The weather forecasting device according to claim 1, wherein the processing circuitry subdivides a grid including the forecasting target area among the plurality of grids indicated by the grid data, and combines a certain grid including an area in which a temporal change of weather data is small with a grid adjacent to the certain grid.

4. The weather forecasting device according to claim 3, wherein the processing circuitry subdivides a grid including an area in which a weather element that affects weather forecast in the forecasting target area can occur among the plurality of grids indicated by the grid data.

5. The weather forecasting device according to claim 1, wherein the processing circuitry is further configured to acquire conversion target data including data indicating a subdividing target grid to be subdivided and data indicating a combining target grid to be combined with an adjacent grid among the plurality of grids indicated by the grid data,
wherein the processing circuitry performs the subdivision and the combination on a basis of the conversion target data.

6. The weather forecasting device according to claim 5, wherein
the processing circuitry is further configured
to select the subdividing target grid and the combining target grid from the plurality of grids indicated by the grid data on a basis of the conversion target data, and
to generate the nonuniform grid data by performing the subdivision of the subdividing target grid and the combination of the combining target grid with the adjacent grid.

7. The weather forecasting device according to claim 6, wherein
the processing circuitry performs supplementation of weather data in the subdivided grids or the combined grid, and
the processing circuitry performs the forecast using the nonuniform grid data after the supplementation is performed.

8. The weather forecasting device according to claim 7, wherein the processing circuitry performs the supplementation of the weather data in the subdivided grids or the combined grid by performing interpolation on a basis of the weather data in a grid adjacent to the subdivided grids and a grid adjacent to the combined grid.

9. The weather forecasting device according to claim 7, wherein the processing circuitry performs the supplementation of the weather data in the subdivided grids and the combined grid by acquiring the weather data in the subdivided grids and the combined grid.

10. The weather forecasting device according to claim 1, wherein
the processing circuitry acquires the grid data obtained by dividing a predetermined area including the forecasting target area into the plurality of grids and another grid data obtained by dividing a surrounding area other than the predetermined area into a plurality of grids,
the processing circuitry generates extended nonuniform grid data indicating a nonuniform grid related to an extended area obtained by joining the predetermined area and the surrounding area and including weather data for each grid of the extended area on a basis of the grid data for each of the predetermined area and the surrounding area, and
the processing circuitry performs the forecast using the extended nonuniform grid data.

11. The weather forecasting device according to claim 10, wherein the processing circuitry is further configured to acquire position data indicating a position of the predetermined area and a position of the surrounding area,
wherein the processing circuitry generates the extended nonuniform grid data on a basis of the position data.

12. The weather forecasting device according to claim 1, wherein the processing circuitry is further configured to determine whether or not a result of the forecast indicated by the weather data forecasted ensures predetermined accuracy,
to regenerate the nonuniform grid data when the processing circuitry has determined that the forecast result does not ensure the predetermined accuracy, and
to regenerate the nonuniform grid data by subdividing a grid among the subdivided grids included in the nonuniform grid and that can be further subdivided.

13. The weather forecasting device according to claim 12, wherein the processing circuitry calculates a matching ratio between the weather data indicating a result of the forecast at a certain time position at a future time, forecasted by the processing circuitry, and weather data actually observed in the forecasting target area at the certain time, and determines that the result of the forecast does not ensure the predetermined accuracy when the calculated matching ratio is less than a threshold.

14. The weather forecasting device according to claim 1, wherein the processing circuitry subdivides a certain grid in which a wind speed and a humidity indicated by the weather data in the certain grid are equal to or more than thresholds among the plurality of grids indicated by the grid data.

15. A weather forecasting system comprising a first weather forecasting device and a second weather forecasting device communicably connected to each other,
wherein the first weather forecasting device includes processing circuitry
to acquire grid data obtained by dividing a predetermined area including a forecasting target area into a plurality of grids and including weather data observed for each of the plurality of grids,
to select a grid to be subjected to grid conversion from the plurality of grids indicated by the grid data as a selected grid and to transmit data indicating the selected grid to the second weather forecasting device,
to perform generation of nonuniform grid data indicating nonuniform grids in which subdivided grids and a combined grid are included on a basis of data indicating a result of the grid conversion transmitted from the second weather forecasting device, and
to perform forecast of weather data of the forecasting target area included in the predetermined area using the nonuniform grid data,
the second weather forecasting device includes another processing circuitry
to perform predetermined processing including grid conversion of the selected grid and transmission of data indicating the result of the grid conversion to the first weather forecasting device, and
the predetermined processing and the generation are performed in parallel.

16. A weather forecasting method using a weather forecasting device, the method comprising:
acquiring grid data obtained by dividing a predetermined area including a forecasting target area into a plurality of grids and including weather data observed for each of the plurality of divided grids;
performing subdivision of a predetermined grid among the plurality of grids indicated by the grid data, combination of another predetermined grid among the grids indicated by the grid data with a grid adjacent to said another predetermined grid, and generating nonuniform grid data indicating nonuniform grids in which the subdivided grids and the combined grid are included and including weather data for each of the nonuniform grids; and
performing forecast of weather data of the forecasting target area included in the predetermined area using the nonuniform grid data.
